(19) United States
(12) Patent Application Publication
(10) Pub. No.: US 2012/0298297 A1
(43) Pub. Date: Nov. 29, 2012

(54) SYSTEM AND METHOD FOR THE PRODUCTION AND USE OF LAMINATION FILMS

(75) Inventors: Gary D. Jerdee, Orange, TX (US); Charles E. Rees, Bartlesville, OK (US); Charles D. Mills, Orange, TX (US)

(73) Assignee: Chevron Phillips Chemical Company LP, The Woodlands, TX (US)

(21) Appl. No.: 13/566,570

(22) Filed: Aug. 3, 2012

Related U.S. Application Data
(62) Division of application No. 12/428,946, filed on Apr. 23, 2009.

(51) Int. Cl. B29C 47/06; B32B 37/10; B32B 37/06

(52) U.S. Cl. 156/308.2; 264/510; 156/60; 425/133.5

(57) ABSTRACT

The techniques disclosed provide methods for making and using lamination films having one, two, three or more layers. The two layer lamination films may have an outer protective material comprising a styrenic polymer and an inner sealing material comprising a poly(ethylene vinyl acetate) (EVA). The three layer lamination films add a center adhesive layer comprising a blend of a low density polyethylene and an EVA. Laminated structures using said lamination films are also described.

### CROSS-REFERENCE TO RELATED APPLICATIONS

This application is a divisional of U.S. patent application Ser. No. 12/428,946 entitled “System and Method for the Production and Use of Lamination Films” filed on Apr. 23, 2009, which is incorporated by reference herein in its entirety for all purposes.

### BACKGROUND

1. Technical Field

The present techniques generally relate to lamination films. More particularly, the present techniques relate to new lamination films incorporating styrenic polymers and methods of producing the same.

2. Description of the Related Art

This section is intended to introduce the reader to various aspects of art which may be related to various aspects of the present techniques which are described and/or claimed below. This discussion is believed to be helpful in providing the reader with background information to facilitate a better understanding of the various aspects of the present techniques. Accordingly, it should be understood that these statements are to be read in this light, and not as any indication of what subject matter may constitute prior art to the present techniques.

Lamination is a process through which one or more sheets or coatings of a laminating material may be applied to an object to protect the surface of, or printing on, the object. The laminating material (e.g., a lamination film or coating) may be stronger and/or more durable than the object being protected. The lamination material may be a clear plastic or polymer designed to permit printing or graphics on the protected surface of the object to be seen, while shielding the surface from damage (e.g., from the environment) and, thus, extending the useful life of the object. Depending on the application, a lamination material or film may be applied to one or more sides of the object or item being protected.

Items typically laminated include educational items, restaurant menus, photographs, historical documents, interior and outdoor signage, posted policies, marketing or sales literature, and so on. In certain applications, the lamination film may prevent the printing and graphics on the protected item from being modified. In other words, attempts to remove or peel the lamination to access the graphics may result in the destruction of the protected surface, and therefore, prevent an unauthorized modification of the graphics or printing. This latter application may be beneficial, for example, with corporate or government issued identification cards, such as identification cards, driver's licenses, and the like.

Two lamination techniques are hot lamination and cold lamination. In hot lamination, the object or surface to be protected may be placed between layers of a lamination film. The combination may be passed through heated rollers, which melt an adhesive disposed on a portion or all of one side of each lamination film facing the surface(s) of the object to be protected. The melted adhesive may adhere to the protected surface and also bind to overlapping portions of the opposing lamination film layers. This overlap results in a final product in which the protected surface or object may be partially or totally encased between two or more layers of lamination film. Full enclosure may better protect the object or item from damage caused by liquids, and environmental conditions, for example.

In cold lamination, the object or surface to be protected may be placed between the lamination films (e.g., between two sheets of lamination film) that may have a pressure sensitive adhesive protected by a release liner, e.g., “peel and stick” adhesives, disposed on a portion or all of one side of each lamination. Shortly before the layers of lamination film are pressed together over the surface of the object or item, the release liner over the adhesive is removed, exposing the pressure sensitive adhesive facing the surface to be protected and allowing the adhesive to bind to the protected surface. Again, as for hot lamination, the two layers of lamination film may overlap (e.g., at the edges of the laminated layers or structure), partially or totally encasing the weaker object or surface to be protected. Cold lamination may be used for surfaces that are heat sensitive, or for convenience.

The thickness of the lamination film selected may be determined by the application needs. For example, single use or short term protection, such as posters advertising an event, may be protected by a lamination film having a thickness of about 1.5 mils (wherein a mil is 1/1000 of an inch). For materials needing a stiffer feel or longer term protection, such as menus or advertising brochures, and so forth, a lamination film of about 3 mils in thickness may be more useful. In cases where very long term protection is needed, such as with identification cards or signage, a lamination film having a thickness of about 6 mils, or even higher, may be beneficial.

Various types of materials may form the lamination film, which may be constructed of multiple layers of the same or different material. One protective layer currently used in lamination films is a biaxially-oriented polyester film which may be pretreated, such as by corona discharge, flame treatment, chemical surface treatment, or sanding, to improve its surface adhesion to other layers of the lamination film. An adhesive layer may be applied to the pretreated surface of the external polyester layer to improve adhesion of the polyester to a subsequent inner layer of a hot-melt adhesive, for example. The adhesive layer improves the adhesion of the polyester film to the inner adhesive layer. The application of the middle and inner layers may be performed using extrusion coating techniques, for example. This type of multilayer lamination film structure may be used in hot lamination.

In other examples with biaxially-oriented polyester film the sealing layer may be a pressure sensitive adhesive instead of a hot-melt adhesive. A release liner is generally placed over the pressure-sensitive adhesive. This type of multilayer lamination film structure may be used in cold lamination. Again, the application of the middle and inner layers may be performed using extrusion coating techniques.

In general, the types of lamination films discussed above that may be used for hot and/or cold lamination are durable and provide beneficial long-term protection to the protected object. Unfortunately, these types of lamination films may have significant associated production costs due to multiple process steps which can be energy intensive. For example, producing a biaxially oriented polyester film generally requires several energy intensive steps. The polyester resin must be pre-dried prior to extrusion to avoid breaking of the polyester chains and a loss of physical and/or optical properties for the lamination film. Further, after the polyester resin is extruded, the biaxial orientation process is performed using a tentering frame, which may be both expensive and energy intensive. In addition, following the orientation process, the pretreatment to improve the surface adhesion of the polyester layer may damage the film surface or otherwise generate scrap material. These techniques require multiple adjustments and may add significant cost and complexity.

### BRIEF DESCRIPTION OF THE DRAWINGS

Advantages of the techniques may become apparent upon reading the following detailed description and upon reference to the drawings in which:

FIG. 1 is a cross section of a two layer lamination film in accordance with an embodiment of the present techniques;

FIG. 2 is a cross section of a laminated structure using a two layer lamination film in accordance with an embodiment of the present techniques;

FIG. 3 is a cross section of a three layer lamination film in accordance with an embodiment of the present techniques;

FIG. 4 is a cross section of a four layer lamination film in accordance with an embodiment of the present techniques;

FIG. 5 is a cross section of a five layer lamination film in accordance with an embodiment of the present techniques;

FIG. 6 is a lamination apparatus in accordance with an embodiment of the present techniques;

FIG. 7 is a block diagram of a two layer cast film co-extrusion system in accordance with an embodiment of the present techniques; and

FIG. 8 is a block diagram of a three layer cast film co-extrusion system in accordance with an embodiment of the present techniques.

### DETAILED DESCRIPTION OF SPECIFIC EMBODIMENTS

One or more specific embodiments of the present techniques will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present techniques include lamination films that may be made from single or multiple layers that include one or more styrenic polymers. In contrast to other types of lamination films, previously discussed, these new films may provide lower-cost lamination materials, due to lower cost production processes and materials. Embodiments of the present techniques may be used in protective structures for numerous items, from single use individual sheets, such as, for example, advertisements for special events, to long term use items, such as photographic identification cards. The decrease in costs may allow for wider use of lamination films. Further, these films could be used in either cold or hot lamination systems and with either small scale, individual laminations or in large scale lamination machines. Moreover, the lamination films of the present techniques may be produced in simple film or sheet co-extrusion process, and may include one, two, or three layers, or more. While not needed, the production of the lamination films may use additional processes, such as extrusion coating, to apply other materials, e.g., water activated adhesives, to the films.

As discussed in more detail below, the present techniques provide for a lamination film including a protective layer (i.e., an external layer) containing at least one styrenic polymer (e.g., about 35% to about 90% of the total lamination film thickness) and a sealing layer containing at least one sealing material (e.g., about 10% to about 65% of the total lamination film thickness). In an embodiment, the protective layer may make up 100% of the protective layer in monolayer films. In another embodiment, the protective layer may make up about 35% to about 90% of the total thickness of the lamination film.

The protective layer is an outermost layer in the lamination film, while the sealing layer may generally be an external layer. The lamination film has a thickness that may be in the range of about 1 mils to about 20 mils, about 3 mils to about 15 mils, about 3 mils to about 6 mils, or about 7 mils to about 12 mils, among others. The sealing material may include any number of materials that may adhere to themselves and/or other materials. For example, such resins may include ethylene vinyl acetate, low density polyethylene, or a combination thereof This ethylene vinyl acetate may have a vinyl acetate content of about 5% to about 35% by weight, 10% to about 30% by weight, 15% to about 25% by weight, among others. In one example, the styrenic polymer of the protective layer may be a styrene butadiene block copolymer having a styrene content of about 50% to about 95% by weight, about 60% to about 90% by weight, about 70% to about 85% by weight, among others. The protective layer may also contain more than one styrenic polymer. In one example, the styrenic polymer of the protective layer may be a blend of a styrenic polymer with polystyrene, and wherein the styrenic polymer is about 20% to about 98%, about 30% to about 95%, about 40% to about 93%, about 50% to about 90%, of the blend in the protective layer by weight. An adhesive layer (e.g., low density polyethylene) may be disposed between the protective layer and the sealing layer. The adhesive layer may be about 25% to about 55% of the total lamination film thickness.

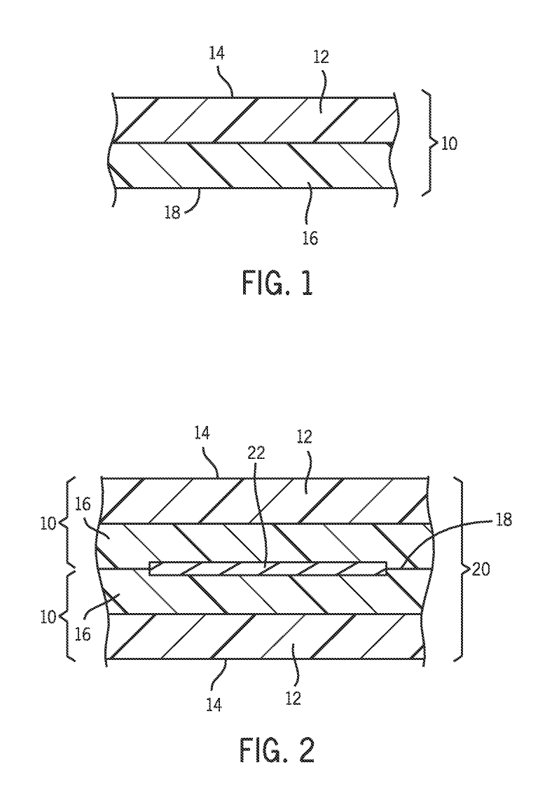

A schematic of a two layer lamination film 10 is shown in FIG. 1. This lamination film has a protective layer 12 made of a protective material having an outermost surface 14 and a sealing layer 16 made from a sealing material having a sealing surface 18. The sealing layer 16 may also be an outermost layer of the two layer lamination film 10. The protective material may include a polymer predominately made from a monovinylarene monomer, for example, styrene, a-methyl styrene, t-butyl styrene, and the like. These polymers are termed styrenic polymers herein. For example, in an embodiment of the lamination film 10, the protective material may be a styrene butadiene copolymer (SBC). The use of an SBC provides a resilient, flexible protective material that would be functional in many applications. Such applications include, for example, single use signs, such as for advertisements for special events. If an application should require a stiffer material, the protective material may be made from a blend of an SBC with a polystyrene homopolymer, or with other styrenic polymers. One of ordinary skill in the art will recognize that other styrenic polymers may be used for the protective material, either neat or in a blend.

For example, an SBC may be blended with numerous other polymers to modify various properties. Styrenic polymers that may be used in these blends include, for example, styrene acrylonitrile (SAN), styrene methyl methacrylate (SMMA), styrene butyl methyl methacrylate (SBMA), and styrene butadiene elastomers, among others. The selection of a polymer blend depends on the final properties desired. For example, the use of styrene acrylonitrile in a blend with an SBC may increase the stiffness and scratch resistance of the protective material, but may also lower the impact resistance and flexibility of the protective material.

The sealing material may be any appropriate material capable of sealing with itself and the underlying substrate to be protected. For example, the sealing material may be ethylene vinyl acetate, with the vinyl acetate content chosen to control the strength of the seal formed. Such an ethylene vinyl acetate material is available from DuPont Chemical Corporation of Wilmington, Del., as the brand Elvax® 3165. Other materials may be used for the sealing material such as low density polyethylene (LDPE). One of ordinary skill in the art will recognize that any number of materials may be used as the sealing material, including combinations of the polymers discussed above.

The thickness of the two layer lamination film 10 may be determined by the properties desired for the final protective laminated structure. In various applications, the thickness may range from about 3 mils up to about 20 mils, while in other applications, the thickness may range from about 4 to 10 mils, or from 6 to 9 mils. The thickness of the individual layers may also control the final properties of the lamination films or laminated structure. In certain embodiments, the styrenic layer may range from 40 to 75 percent of the final thickness of the lamination film or structure.

The use of these lamination films in protecting a surface is shown by the cross-section of a laminated structure 20 in FIG. 2. As shown in FIG. 2, an item to be protected 22 may be placed between two individual layers of two layer lamination film 10. The laminated structure 20 may then be formed when the sealing surface 18 of the sealing layer 16 of each of two pieces of two layer lamination film 10 are sealed to the item to be protected 22. Where the sealing layers 16 directly overlap each other, the sealing surface 18 of each piece of two layer lamination film 10 may be directly sealed to the opposing sealing surface 18. The item to be protected 22 may be vulnerable to attack by water or other weather conditions, making its complete incorporation into the laminated structure 20 beneficial. Examples of materials that may need protection by lamination include menus or other printed paper materials subject to staining or damage, printed photographs using water-based inks that may be subject to running or dissolution, photographs, photographic identification cards, or any number of other materials benefiting from protection from wear and the elements.

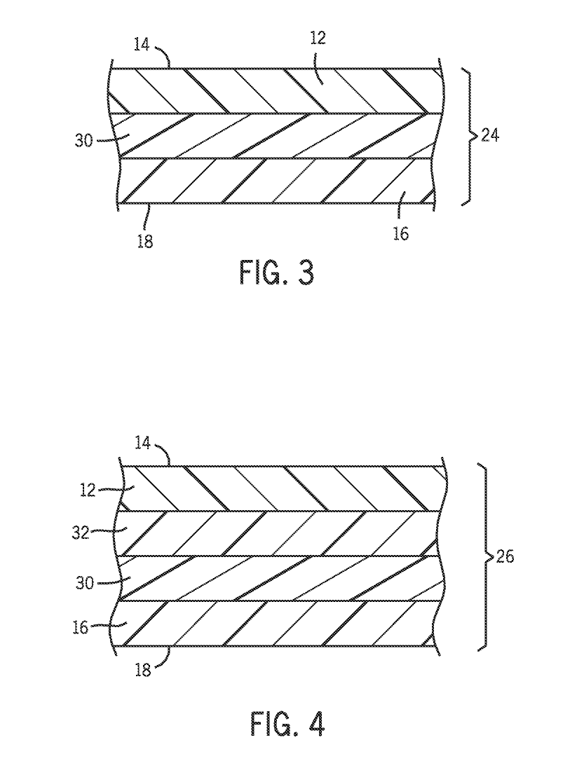

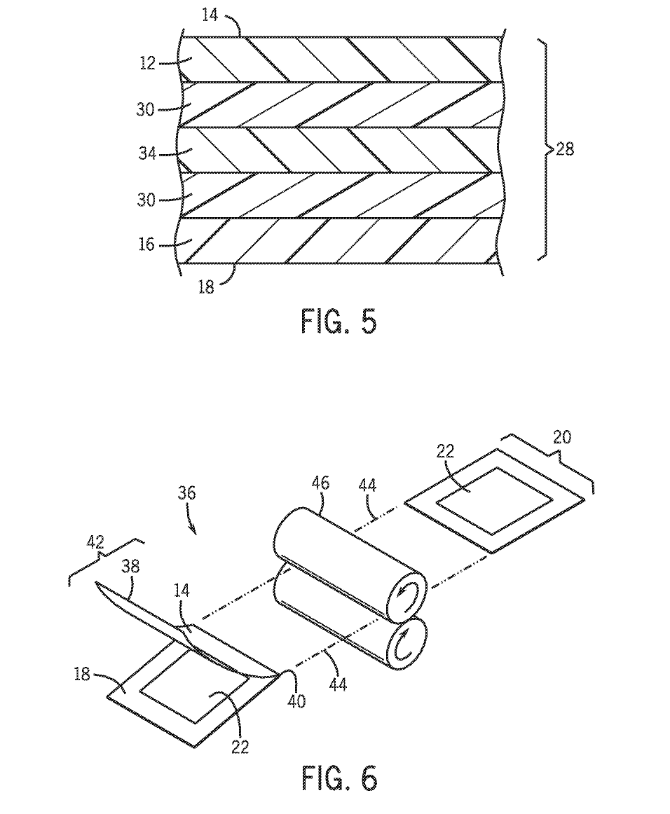

The formation of a laminated structure 20 is not limited to the use of two layer lamination films 10. The laminated structures 20 may be formed using a single layer, having a styrenic polymer, or multiple polymer layers, of which a protective layer may contain a styrenic polymer. For example, the use of single layer lamination films formed using only styrenic polymers may provide advantages in single use items having a shorter lifespan, such as single-event advertising posters. In other examples, a three layer lamination film 24 as shown in the cross-section in FIG. 3, a four layer lamination film 26 as shown in the cross-section in FIG. 4, and a five layer lamination film 28 as shown in the cross-section in FIG. 5 are among others that may be used.

As for the two layer lamination film 10 discussed above, the three layer lamination film 24 shown in FIG. 3 may have a protective layer 12 made up of a protective material having an outermost surface 14. The three layer lamination film 24 may also have a sealing layer 16 made from a sealing material having a sealing surface 18. In addition to having a protective layer 12 and a sealing layer 16, the three layer lamination film 24 may also have an adhesive layer 30, which is disposed between the protective layer 12 and the sealing layer 16. The adhesive layer 30 may lower the cost of the three layer lamination film 24 or increase the adhesion between the protective layer 12 and the sealing layer 16.

Materials that may be used as the adhesive material include high vinyl acetate content ethylene vinyl acetate copolymers, such as Elvax® 3190, available from DuPont Corporation, which contains 25% vinyl acetate by weight. Other materials that may be used as the adhesive material include very low density polyethylene resins, low density polyethylene resins, and the like. One of ordinary skill in the art will recognize that any number of materials have similar properties may be used as the adhesive material. Further, these materials may be used in neat form, or in blends.

In the three layer lamination film 24, the composition of the sealing layer 16 may be chosen as described with respect to FIG. 2, above, or may be a general low density polyethylene. For example, the low density polyethylene may have a density of between about 0.91 and 0.95 grams per centimeter cubed (g/cm³), between about 0.92 and 0.94 g/cm³, or between about 0.92 and 0.93 g/cm³. In an embodiment of the present techniques, the low density polyethylene has a density of 0.927 g/cm³, which is available as Marfiex® PE 5355 Polyethylene from Chevron Philips Chemical Company LP of The Woodlands, Tex. The use of a low density polyethylene layer as the sealing layer 16 may provide a further advantage in increasing the tear strength of the laminated structure 20. Such improvements in tear strength may be beneficial in longer-lasting protection applications, such as with photographic identification badges.

More complex layer structures may be used in the present techniques, as illustrated by the cross sectional views shown in FIGS. 4 and 5. FIG. 4 is a cross section of a four layer lamination film 26 that may have a protective layer 12 made up of a protective material having an outermost surface 14, as described above. The four layer lamination film 26 may also have a sealing layer 16 made from a sealing material having a sealing surface 18. In addition to having a protective layer 12 and a sealing layer 16, the four layer lamination film 26 may also have an adhesive layer 30 and second layer of sealing material 32, both disposed between the protective layer 12 and the sealing layer 16. In an embodiment, the second layer of sealing material 32 is formed between the protective layer 12 and the adhesive layer 30. The second layer of sealing material 32 may be identical to the sealing layer 16 used to form the sealing surface 18 or may have a different blend composition. The adhesive material is as discussed with respect to FIG. 3, above. The formation of additional layers may reduce the amount of curl in the film, as discussed in the experimental section below.

FIG. 5 is a cross sectional view of a five layer lamination film 28 that may have a protective layer 12 made up of a protective material having an outermost surface 14, as described above. The five layer lamination film 28 may also have a sealing layer 16 made from a sealing material having a sealing surface 18. In addition to having a protective layer 12 and a sealing layer 16, the five layer lamination film 25 may also have a second layer of protective material as a stiffening layer 34 in the center of the structure disposed between two adhesive layers 30. Generally, the stiffening layer 34 may have the same composition as the protective layer 12 having an outermost surface 14. Similarly, each of the two adhesive layers 30 may have the same composition as each other. However, the compositions of the protective material used in the protective layer 12 and stiffening layer 34 or the adhesive materials used in each of the two adhesive layers 30 may differ. For example, if a separate extruder is used for each layer in the structure.

The thickness of the three layer lamination film 24, four layer lamination film 26, or five layer lamination film 28 may be determined by the properties desired for the final protective laminated structure. In various applications, the thickness may range from about 3 mils up to about 20 mils, while in other applications, the thickness may range from about 4 to 10 mils, or from 6 to 9 mils. The thickness of the individual layers may also control the final properties of the lamination films or laminated structure. In certain embodiments, the styrenic layer may range from 40 to 75 percent of the final thickness of the lamination film or structure.

The lamination films discussed above may be used in any number of different lamination processes. For example, a single sheet lamination process 36 is shown in the perspective view in FIG. 6. As shown in this figure, an item to be protected 22 may be placed in contact with at least one layer of a lamination film. The lamination film may be one sheet of lamination film, two sheets of lamination film, or a single sheet of lamination film 38 having a crease or fold 40 to form a pocket. This pocket may be formed in lamination film 38 to have the outermost surface 14 facing outwards and the sealing surface 18 facing the item to be protected 22. The resulting assembly 42 may be placed on a path 44 that takes it through a pair of heated rollers 46 contained in a lamination machine (not shown). The heated rollers both melt the layers and exert pressure on the outsides of the assembly 42 to seal the two sides together and form a laminated structure 20. Upon cooling, the protected item 22 may be partially or completely contained within a laminated structure 20 and protected from the environment.

Other lamination systems and processes applicable with present techniques may include, for example, large scale commercial laminators where lamination films are stored on rolls that are continuously fed into the lamination machine. Further, the top and bottom layers of the laminated structure do not have to be identical. In some instances, thicker lamination films may be combined with thinner lamination films. In other instances this may provide improved readability of the graphics along with the desired stiffness. In some embodiments a clear lamination film may be used in combination with an opaque lamination film. In other embodiments, a lamination film may be used as a top or transparent layer over a layer of another polymer, such as polyethylene, polypropylene, or other protective opaque or translucent polymer.

The temperature used for the heated rollers 46 depends on the structure of the lamination film selected. For example, the heated rollers may be between about 120° F. and 240° F., between about 140° F. and 220° F., or between about 150° F. and 220° F. for the two layer lamination film 10 discussed with reference to FIG. 1. Higher temperatures for the heated rollers 46 may be required when using the lamination films with greater than two layers discussed with reference to FIGS. 3-5. However, the upper temperature may be limited by the styrenic polymer selected. For example, if the protective material is a styrene butadiene copolymer, as discussed above, significant shrinkage resulting in the formation of wrinkles may occur if the temperature of the rollers is set above about 240° F.

In addition to the hot lamination techniques discussed above with respect to FIG. 6, the lamination films of the present techniques may also be used in other types of lamination procedures. For example, a single-layer, two-layer, three-layer, four-layer, or five-layer lamination film may have a pressure sensitive adhesive as the sealing layer 16, protected by a release liner. This lamination film or structure may be used for lamination by removing the release liner of two pieces of lamination film to expose the sealing surface 18 of the sealing layer 16 of pressure sensitive adhesive and apply it to either side of an item to be protected 22. The pressure sensitive adhesive may be applied or disposed onto co-extruded structures by extrusion coating or by a liquid application process, among other systems. Further, lamination of two films may take place using a water activated adhesive. In this system, after coextrusion of the lamination film, a water-activated adhesive may be applied to the back of the lamination film and allowed to dry. To laminate a structure using a water-based adhesive, water is applied to the water-based adhesive surfaces of the lamination film and then a sheet of each lamination film with the wetted adhesive facing the item to be protected 22 is applied.

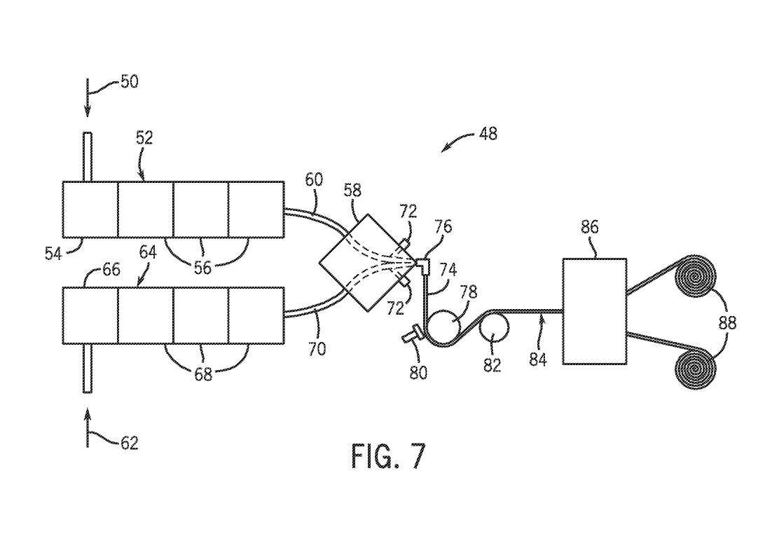

The lamination films of the present techniques may be produced by any number of techniques. For example, the two layer lamination film 10 discussed with respect to FIG. 1 may be produced by the extrusion process 48 of FIG. 7. In this system, the protective material 50 may be fed into a first extruder 52. In the first extruder 52, the protective material 50 is heated and melted in a first feed zone 54. The first feed zone 54 then forces the partially molten pellets into the melt zones 56 of the first extruder 52. In the melt zones 56 of the first extruder 52, the protective material 50 is melted, pressurized, and forced out into the co-extrusion film die 58 as a first melt. The first extruder 52 may be directly connected to the co-extrusion film die 58 or may be connected by a heated transfer line 60, which may be maintained at about the same temperature as the melt zones 56.

The sealing material 62 may be fed into a second extruder 64. In the second extruder 64, the sealing material 62 is partially melted in a second feed zone 66, before being forced into the melt zones 68 of the second extruder 64. In the melt zones 68 of the second extruder 64, the sealing material 62 is melted and pressurized, prior to being forced into the co-extrusion film die 58 as a second melt. As for the first extruder 52, the second extruder 64 may be directly connected to the co-extrusion film die 58 or may be connected by a heated transfer line 70, which may be maintained at about the same temperature as the melt zones 68.

In the co-extrusion film die 58, the protective material 50 of the first melt and the sealing material 62 of the second melt are co-extruded into a film structure having a protective layer and a sealing layer. The thickness of the individual layers may be controlled by adjustment screws 72. The molten two-layer film structure 74 is forced out of a co-extrusion die head 76 onto a chill roll 78. An air knife 80 blows a stream of cool air opposite the chill roll 78 to help solidify the molten two layer structure. The film may be kept tight to avoid wrinkles by one or more tension rollers 82. The final solidified lamination film 84 may be fed into a slitter 86. In the slitter 86, the lamination film 84 may be slit into the final sizes required by the customers prior to being rolled up on take-up rolls 88.

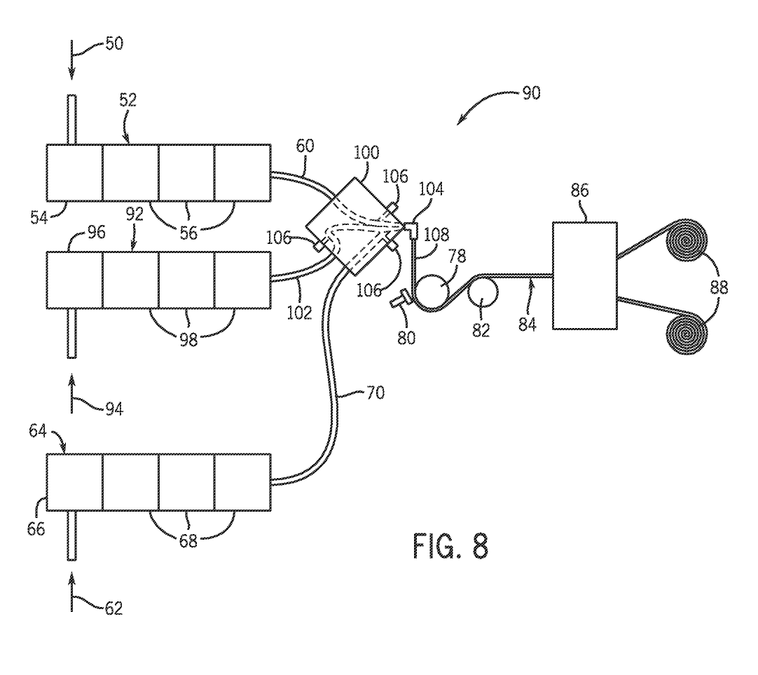

The production of three layer lamination films 24, 25, and 26, discussed with respect to FIGS. 3-5, may be performed by the three layer extrusion process 90 of FIG. 8. This process 90 is similar to the process 48 discussed with respect to FIG. 7. In process 90 shown in FIG. 8, a third extruder 92 is added in between the first extruder 52 and second extruder 64, discussed with respect to FIG. 7, to melt the adhesive material 94. This adhesive material 94 may be fed into the feed throat zone 96 of the third extruder 92. In the feed throat zone 96 of the third extruder 92, the adhesive material 94 is partially melted and forced into the melt zones 98. In the melt zones 98 of the third extruder 92 the adhesive material 94 is melted, pressurized, and forced into a three layer co-extrusion die 100. As described above with respect to FIG. 7, the third extruder 92 may be directly connected to the three layer co-extrusion die 100 or may be connected using a heated transfer line 102, which may be maintained at about the same temperature as the melt zones 98.

In the three layer coextrusion die 100, the molten adhesive material 94 from the third extruder 92 is combined into a layered structure with the molten protective material 50 from the first extruder 52 and the molten sealing material 62 from the second extruder 64. The layered structure is forced out of the three layer co-extrusion die 100 through a three layer co-extrusion die head 104 which may be pointed downwards, as shown in FIG. 8. The thickness of each layer may be set by adjustment screws 106 on the three layer co-extrusion die 100. A chill roll 78 may be used to cool and solidify the molten three layer structure 108 from the three layer co-extrusion die head 104. As previously noted, an air knife 80 may be used to chill the outside of the film to decrease wrinkles in the final lamination film 84. One or more tension rollers 82 may be used to hold a continuous tension on the lamination film 84. The lamination film 84 may be fed into a slitter 86 where it may be cut into the final product dimensions, prior to being wound up on take-up rolls 88.

The four and five layer lamination film structures 26 and 28, discussed with respect to FIGS. 4 and 5, may be made using a process similar to that described in FIG. 8 for making the three layer lamination film structures 24. To form these film structures, three extruders are also typically used, however, the flow from one or two of the extruders may be divided within the coextrusion film die to form the additional layers. If different compositions are used for each layer, as discussed with respect to FIG. 5 above, a separate extruder may be used for each individual layer composition used.

### EXAMPLES

The following examples are set forth to provide those of ordinary skill in the art with a detailed description of how the methods disclosed herein are evaluated, and are not intended to limit the scope of the present techniques.

A number of lamination film samples were produced to determine the properties of lamination films that may be made using styrenic polymers. These samples included monolayer lamination films including only styrenic polymers, two layer films that included styrenic polymers and a sealing material, and some three layer films that included a center adhesive material. The two and three layer lamination films were made using the procedures discussed with respect to FIG. 7, wherein monolayer films were made using only a single extruder. Some two layer lamination films were made using a blown film process, as discussed below. The materials used for the production of the lamination film samples and the test procedures for determining the properties of the individual films are discussed below. The production conditions and results obtained for the individual lamination films are shown in the tables that follow. The reference numbers in the discussion below refer to those shown in FIGS. 1-5 above.

A commercially produced lamination film was used as a control (hereinafter referred to as “OPET Control Film”) for comparison to the experimental lamination films, as shown in the tables below. The commercial sample was made up of three layers, a protective layer of about 1.4 mil in thickness, made from oriented polyethylene terphthalate (PET), an adhesive layer of about 0.6 mil in thickness, made from a low density polyethylene (LDPE), and a sealing material of about 0.85 mil in thickness, made from an poly(ethylene vinyl acetate) (EVA) having a vinyl acetate content of at least about 12%, by weight. The construction of the OPET Control Film indicates that it was likely produced using an extrusion coating operation, in which an oriented PET is coated with a LDPE/EVA extrudate. Since LDPE does not adhere well to PET, the PET may need to be primed to increase the adhesion. This process provides a very strong protective film layer, but has significant costs associated with the complexity of the production process.

### Materials

### Styrene Butadiene Copolymer

The styrenic polymer used for the examples was a styrene butadiene copolymer (SBC) made of sequential blocks of styrene and butadiene. The SBC contains about 50% to about 95% styrene by weight and about 50% to about 5% butadiene by weight. One such material may be available as K-Resin® DK11, which is an SBC available from Chevron Phillips Chemical Company LP of the Woodlands, Tex. One skilled in the art will recognize that any number of other commercially available SBCs may be used in embodiments of the present technique. Such additional SBCs include K-Resin® SBC grades KR05, KR01, KK38, and others available from Chevron Phillips Chemical Company LP, as well as similar SBCs available from other suppliers.

### Poly(Ethylene Vinyl Acetate)

The poly(ethylene vinyl acetate) (EVA) used in the examples was a random copolymer of polyethylene and vinyl acetate having around 18% vinyl acetate, by weight. Such material may be commercially available as Elvax® 3165 Resin from E.I. du Pont de Nemours and Company, Inc. One skilled in the art will recognize that other suppliers provide similar grades, such as Evatane® 18-150 Resin, available from Arkema Company of Philadelphia, Pa. Further, grades having other levels of vinyl acetate may be used, depending on the properties desired.

### Low Density Polyethylene

The low density polyethylene (LDPE) used in the examples was a film grade LDPE, which may be commercially available as MarFlex® PE 4517 Polyethylene from Chevron Phillips Chemical Company LP. This material has a density of about 0.923 g/cm3 (measured using ASTM D1505) and a melt index of about 5.1 g/10 min (under ASTM D1238, Condition E). One of ordinary skill in the art will recognize that other commercially available LDPE grades, of varying densities and melt indices may be used in embodiments the present techniques.

### Polystyrene

The polystyrene (PS) used in the examples was a general purpose PS with a melt flow rate of 7 g/10 min (measured by ASTM D1238, Condition G). Such a grade may be commercially available as MC3200 from Chevron Phillips Chemical Company LP. One of ordinary skill in the art will recognize that other commercially available PS grades may be used in the current techniques.

### High Impact Polystyrene

A small amount of high impact polystyrene (HIPS) may optionally be used as an antiblocking agent to decrease the tendency of the lamination film to adhere to itself The grade used in the examples was EA8100, commercially available from Chevron Phillips Chemical Company LP. One of ordinary skill in the art will recognize that other commercially available HIPS may also be used in the current techniques.

### Test Procedures

Surface and optical properties of the lamination films were measured using the following ASTM testing procedures. The haze was measured using ASTM D1003-00: “Standard Test Method for Haze and Luminous Transmittance of Transparent Plastics.” The gloss was measured using ASTM D2457-03: “Test Method for Specular Gloss of Plastic Films and Solid Plastics,” using a 60% incidence angle. The coefficient of friction was measured using ASTM D1894-06: “Standard Test Method for Static and Kinetic Coefficients of Friction of Plastic Film and Sheeting,” using a 200 g weight to hold the surfaces together.

The physical properties of the lamination films were measured using the following test procedures. Shrinkage was measured using ASTM D2732-03: “Standard Test Method for Unrestrained Linear Thermal Shrinkage of Plastic Film and Sheeting.” Elmendorf tear was measured using D 1922-06a: “Standard Test Method for Propagation Tear Resistance of Plastic Film and Thin Sheeting by Pendulum Method.” The tensile strength, elongation, and 1% secant modulus (i.e., stiffness) were measured using ASTM D882-02: “Standard Test Method for Tensile Properties of Thin Plastic Sheeting.”

The vapor transmission rates of the lamination films were measured using the following test procedures. The water vapor transmission rates were measured using ASTM F 1249-06: “Standard Test Method for Water Vapor Transmission Rate Through Plastic Film and Sheeting Using a Modulated Infrared Sensor.” The oxygen transmission rates were measured using ASTM D3985-05: “Standard Test Method for Oxygen Gas Transmission Rate Through Plastic Film and Sheeting Using a Coulometric Sensor.”

The curl of the lamination films was measured using an internal technique that provided relative comparisons between samples. This value was merely used to determine comparisons between the operational characteristics of the lamination film samples. The technique used a glass plate with a marked grid as a support for a lamination film sample. The lamination film sample was laid over the glass plate and held in place by a metal frame that was entirely outside of the area of the marked grid. A razor blade was then used to cut diagonal lines in the lamination film sample between opposing corners of the grid. The lamination film would then curl both across the processing (e.g., flow) direction of the film sample (designated TD for transverse direction) and in the processing direction of the film sample (designated MD for machine direction). After 30 seconds, the location of the leading edge of each section of the curled lamination film was measured by vertically observing its position on the grid. A corresponding measurement was taken from the center (i.e., the intersection of the perpendicular cuts in the lamination film) to the edge of the grid. The curl was then calculated as a percentage ratio of the location of the leading edge of the curl to the length from the edge of the grid to the center point.

### Examples of Monolayer Lamination Film Structures

Monolayer lamination films were prepared using a single extruder in a cast film process, analogous to that discussed with respect to FIG. 7. The extruder conditions used are shown in Table 1 below.

The properties that may be obtained from monolayer lamination films made from an SBC with various amounts of added polystyrene are shown in Table 2. As tabulated, a first run containing no polystyrene was tested, and then a series of samples were made, wherein the amount of polystyrene was set to 20%, 30%, and 40%, by weight of the polymer.

TABLE 1
CONDITIONS FOR PRODUCING MONOLAYER LAMINATION
FILMS

| Condition | | Set point | |
|---|---|---|---|
| Output | | 250 | lbs/hr |
| Extruder | Zone 1 | 350° | F. |
| Temperature | Zone 2 | 380° | F. |
| Profile | Zone 3 | 400° | F. |
| | Zone 4 | 400° | F. |
| Downstream | | 400° | F. |
| Die | | 425° | F. |
| Primary Chill Roll | | 120° | F. |
| Film Gauge | | 1.5 | mils |

As shown by the results in Table 2, the addition of increasing levels of polystyrene blended into the SBC may have a significant effect on lamination film stiffness. Over the polystyrene addition range studied of 0% through 40%, the lamination film stiffness, as measured by 1% secant modulus, increased by approximately 44% in the machine direction of the film and by over 100% in the transverse or cross direction of the lamination film. Further, the addition of polystyrene to the SBC at levels below 30% had little or no effect on lamination film haze or gloss. However, at an addition level of 40% of polystyrene into the SBC, both the film haze and film gloss may show a small level of improvement. Moreover, the addition of polystyrene to the SBC across the levels studied had little or no effect on tear strength. However, as seen from the data, the addition of polystyrene enhanced the tensile properties of the lamination film and impacted the elongation of the film. As these results show, the stiffness of the final product may be generally adjusted by the selection of the styrenic polymer blend. This stiffness could be selected to match the application.

TABLE 2
COMPOSITIONS AND PROPERTIES FOR
MONOLAYER LAMINATION FILMS

| Test | | Units | Film 1 | Film 2 | Film 3 | Film 4 |
|---|---|---|---|---|---|---|
| Gauge | Target | mil | 1.5 | 1.5 | 1.5 | 1.5 |
| | Actual | mil | 1.24 | 1.24 | 1.23 | 1.24 |
| SBC (DK11) | | wt % | 97 | 77 | 67 | 57 |
| PS (MC3200) | | wt % | 0 | 20 | 30 | 40 |
| HIPS (EA8100) | | wt % | 3 | 3 | 3 | 3 |
| Haze (Total) | | % | 2.64 | 2.61 | 2.63 | 1.94 |
| Gloss | | % | 161 | 163 | 163 | 170 |
| Elemendorf | MD² | g/mil | 9 | 8 | 7 | 6 |
| Tear | TD³ | g/mil | 21 | 16 | 16 | 13 |
| | MD^{1,2} | g | 14 | 12 | 11 | 9 |
| | TD^{1,3} | g | 32 | 24 | 24 | 20 |
| Tensile | MD² | psi | 4390 | 5300 | 5600 | 6900 |
| Yield | TD³ | psi | 2800 | 3700 | 3900 | 4200 |
| | MD^{1,2} | lb/f | 6.6 | 7.9 | 8.4 | 10.3 |
| | TD^{1,3} | lb/f | 4.2 | 5.5 | 5.8 | 6.4 |
| Tensile | MD² | psi | 5600 | 4300 | 4700 | 6000 |
| Break | TD³ | psi | 3600 | 2700 | 2800 | 4200 |
| | MD^{1,2} | lb/f | 8.4 | 6.5 | 7.1 | 9.0 |
| | TD^{1,3} | lb/f | 5.4 | 4.0 | 4.2 | 6.4 |
| Elongation | MD² | % | 195 | 128 | 134 | 8 |
| | TD³ | % | 319 | 36 | 21 | 3 |
| 1% Secant | MD² | psi | 211000 | 260000 | 271000 | 303000 |
| Modulus | TD³ | psi | 111000 | 168000 | 174000 | 224000 |
| | MD^{1,2} | lb/f | 3.2 | 3.9 | 4.1 | 4.6 |
| | TD^{1,3} | lb/f | 1.7 | 2.5 | 2.6 | 3.4 |

¹Values normalized for film thickness.
²MD stands for machine direction, or parallel to the direction of processing.
³TD stands for transverse direction, or perpendicular to the direction of processing.

### Examples of Two Layer Lamination Film Structures

Exemplary two layer lamination film structures that included an SBC in a protective layer 12 and an adhesive polymer in a sealing material 62 were generated using a blown film line, following the conditions in Table 3. The extruder setup was similar to that discussed with respect to FIG. 7, with the exception that a blown film die was substituted for the co-extrusion film die 58 shown. In the blown film procedure, a tube of molten polymer is vertically extruded from the blown film die and then inflated by an air injection device located in the center of the blown film die. The increase in size of the bubble diameter over the die opening, designated as the blow-up ratio, is shown in Table 4. After vertical extrusion, the bubble is cooled in a vertical frame or tower and then collapsed through a set of polish rollers located at the top of the frame. Once the tube is collapsed, the film may be kept tight by tension rollers 82, and sent to a slitter to open the tube, flatten the tube, and slit the flattened film into appropriate sizes 68, prior to being wound up on take up rolls 70. As shown in Table 3, structures 2, 3, and 4 had polystyrene added to the styrene butadiene copolymer in the protective layer 12.

The properties obtained for lamination films made using these techniques are shown in Table 4, below. One property that may be more problematic is the increased shrinkage that may be seen for films produced by a blown film process. This shrinkage may be due to increased orientation introduced into the polymers in these films versus a cast film process. As shown in Table 4, this may be more significant for these lamination films than for the OPET Control Film. Accordingly, the current techniques have focused more on cast film techniques, as shown in FIGS. 5 and 6, than on films produced by a blown film blown film process.

Although the stiffness and shrinkage of the two layer lamination films were not as good as the OPET Control Film, the easier production techniques may give lamination films produced by the current techniques a significant cost advantage. Further, the lower stiffness may provide advantages in applications in which higher stiffness may actual be a problem, such as, for example, in the lamination of architectural drawings, posters, or other items that may need to be rolled up for storage.

TABLE 3
COMPOSITIONS OF AND CONDITIONS FOR PRODUCING TWO LAYER FILMS

| | Film 1 | | Film 2 | | Film 3 | | Film 4 | |
|---|---|---|---|---|---|---|---|---|
| | Protective | Sealing | Protective | Sealing | Protective | Sealing | Protective | Sealing |
| Extruder Set Up | Layer | Layer | Layer | Layer | Layer | Layer | Layer | Layer |
| Sheet Structure | A | B | A | B | A | B | A | B |
| Layer Ratio (% of | 33.5 | 66.5 | 80.0 | 20.0 | 80.0 | 20.0 | 80.0 | 20.0 |
| total thickness) | | | | | | | | |
| Layer Thickness | 1 | 2 | 2.4 | 0.6 | 2.4 | 0.6 | 2.4 | 0.6 |
| (mil) | | | | | | | | |
| Zone 1. (° F.) | 370 | 410 | 380 | 370 | 380 | 370 | 380 | 370 |
| Zone 2. (° F.) | 370 | 420 | 400 | 370 | 400 | 370 | 400 | 370 |
| Zone 3. (° F.) | 370 | 420 | 400 | 370 | 400 | 370 | 400 | 370 |
| Die Temp (° F.) | 380 | 380 | 400 | 400 | 400 | 400 | 400 | 400 |
| Base Resin | DK11 | EVA | DK11 | EVA | DK11 | EVA | DK11 | EVA |
| Base Resin (wt %) | 100.0 | 40.0 | 67.0 | 100.0 | 87.0 | 100.0 | 77.0 | 100.0 |
| 1st Blend Resin | — | 4517 | EA8100 | — | EA8100 | — | EA8100 | — |
| 1st Blend Resin | — | 60.0 | 3.0 | — | 3.0 | — | 3.0 | — |
| (wt %) | | | | | | | | |
| 2nd Blend Resin | — | — | EA3710 | — | EA3710 | — | EA3710 | — |
| 2nd Blend Resin | — | — | 30.00 | — | 10.00 | — | 20.00 | — |
| (wt %) | | | | | | | | |

| | | | | |
|---|---|---|---|---|
| Polish Roll Temp. | 160 | 170 | 170 | 170 |

The heat sealing properties of the lamination films were comparable to that of the OPET Control Film, with initiation around 200° F. This property is controlled by the sealing material, or EVA, in both the OPET Control and test films. As shown in Table 4, all of the experimental lamination films had higher Elemendorf tear strength than the OPET Control Film. This indicates that the experimental lamination films may be less likely to tear during use.

TABLE 4
PROPERTIES OBTAINED FOR TWO LAYER LAMINATION FILMS

| | | | OPET | | | | |
|---|---|---|---|---|---|---|---|
| | | | Control | | | | |
| Test | | Units | Film | Film 1 | Film 2 | Film 3 | Film 4 |
| Blow up ratio | | | | 1.75 | 2 | 2.5 | 3 |
| Haze | | % | 93 | 16.6 | 15.5 | 11.2 | 9 |
| Gloss | Outermost | % | 123 | 108 | 108 | 110 | 109 |
| | Sealing | % | 10 | 44 | 55 | 72 | 74 |
| COF | Outermost | | 0.23 | 0.52 | 0.38 | 0.3 | 0.37 |
| | Sealing | | 0.67 | 0.66 | 0.22 | 0.23 | 0.42 |
| Shrinkage @ | MD¹ | % | 0 | 43 | 40 | 33 | 29 |
| 225 F. | TD² | % | 0 | 3 | 8 | 32 | 29 |
| Shrinkage @ | MD¹ | % | 1 | 54 | 49 | 40 | 39 |
| 250 F. | TD² | % | 0 | 4 | 10 | 27 | 33 |
| Shrinkage @ | MD¹ | % | 1 | 61 | 57 | 51 | 46 |
| 275 F. | TD² | % | 0 | 4 | 10 | 28 | 35 |
| Shrinkage @ | MD¹ | % | 2 | 60 | 62 | 50 | 51 |
| 300 F. | TD² | % | 1 | 4 | 9 | 28 | 35 |
| Shrinkage | MD¹ | % | 2 | 64 | 64 | 56 | 55 |
| 325 F. | TD² | % | 2 | 3 | 10 | 28 | 35 |
| Elmendorf | MD¹ | g/mil | 12 | 21 | 22 | 34 | 38 |
| Tear | TD² | g/mil | 15 | 113 | 97 | 73 | 95 |
| WVTR | — | g/100 | 0.477 | 2.37 | 2.45 | 2.49 | 2.21 |
| | | in²/day | | | | | |
| OTR | — | cc/100 | 21 | 133 | 138 | 144 | 141 |
| | | in²/day | | | | | |
| Tensile | MD¹ | psi | None | 2300 | 2400 | 2200 | 2200 |
| Yield | TD² | psi | None | 1900 | 1900 | 20007 | 1900 |
| Tensile @ | MD¹ | psi | 14000 | 6100 | 6100 | 5500 | 5700 |
| Break | TD² | psi | 14700 | 5100 | 4900 | 5600 | 5500 |
| Elongation | MD¹ | % | 122 | 356 | 348 | 376 | 395 |
| | TD² | % | 105 | 448 | 428 | 393 | 374 |
| Secant | MD¹ | psi | 329000 | 85000 | 89000 | 76000 | 77000 |
| Modulus | TD² | psi | 357000 | 52000 | 58000 | 61000 | 64000 |

¹MD stands for machine direction, or parallel to the direction of processing.
²TD stands for transverse direction, or perpendicular to the direction of processing.

### Examples of Three Layer Lamination Film Structures

The results obtained for the two layer and monolayer lamination films indicated that a three layer lamination film may provide even more cost savings. In this type of construction, an adhesive layer 30 which may include lower cost materials is included between the protective layer 12 and the sealing layer 16. Two sets of three layer lamination films, using two different layer thicknesses, were generated to test the properties. The conditions used for extruding the films were identical and are shown in Table 5.

TABLE 5
CONDITIONS FOR PRODUCING THREE LAYER LAMINATION
FILMS

| | | | |
|---|---|---|---|
| Layer | Protective Layer | Adhesive Layer | Sealing Layer |

| | | |
|---|---|---|
| Output | 250 | lbs/hr |

| | | | | |
|---|---|---|---|---|
| Extruder | Zone 1 | 350° F. | 350° F. | 350° F. |
| Profile | Zone 2 | 380° F. | 380° F. | 380° F. |
| | Zone 3 | 400° F. | 400° F. | 400° F. |
| | Zone 4 | 400° F. | 400° F. | 400° F. |

| | | | |
|---|---|---|---|
| Downstream | 400° F. | 400° F. | 400° F. |

| | | |
|---|---|---|
| Die | 425° | F. |
| Primary Chill Roll | 120° | F. |
| Film Gauge | 3 & 5 | mils |

### First Structure for Three Layer Lamination Films

The first set of three layer lamination films tested were three mils thick, and used a layer distribution of 35% for the protective layer 12, 45% for the adhesive layer 30, and 20% for the sealing layer 16, each a percentage of the total thickness of the lamination film. The results obtained from tests on these films are shown in Table 6. Another set of lamination films were produced at a five mil layer thickness, using the same layer thickness ratios. The results obtained from tests on these films are shown in Table 7.

As shown in Tables 6 and 7, all of the test films were less stiff than the existing lamination film used in the market. However, the lower cost of the films may allow the gauge of the films to be increased to adjust the stiffness while retaining the benefits. A comparison of the 1% secant modulus of the test films and the OPET Control Film indicates that even the stiffest construction would need to be increased by a factor of 2 to 2.5 to achieve the same stiffness (lbf) as the OPET Control Film.

Fortunately, as previously noted, the stiffness of the experimental lamination films may not limit their use in certain applications, such as in page protection and posters, where stiffness may be not as highly valued and the surface of the item being protected may be relatively smooth. In some applications, such as blueprint protection where the lamination may be rolled-up for storage, the lower stiffness of the films of the present techniques may actually be beneficial.

Further, as shown in Tables 6 and 7, the three layer structures demonstrated similar outermost surface gloss as the OPET Control Film. The test lamination films may also show lower haze than the OPET Control Film. The low haze of the sealing surface 18 of the OPET Control Film may be caused by embossing of the sealing surface. In commercially produced films, the sealing surface 18 may be embossed to allow air to escape during the lamination process. For the same reasons, it may be beneficial to emboss certain embodiments of the present lamination films in commercial production. Accordingly, any difference in haze between the OPET Control Film and test films would be substantially mitigated or would disappear.

TABLE 6
COMPOSITION OF AND PROPERTIES FOR FIRST
THREE LAYER STRUCTURES - THREE MIL

| | | | OPET | | | | | |
|---|---|---|---|---|---|---|---|---|
| | | | Control | Film | Film | Film | Film | Film |
| Test | | Units | Film | 3-1 | 3-2 | 3-3 | 3-4 | 3-5 |
| Gauge | Target | mil | — | 3 | 3 | 3 | 3 | 3 |
| | Actual | mil | 3 | 2.58 | 2.64 | 2.65 | 2.69 | 2.72 |
| Protective Material | | wt % | OPET | 97% | 77% | 67% | 67% | 57% |
| | | | | K-Resin | K-Resin | K-Resin | K-Resin | K-Resin |
| | | | | 3% | 20% | 30% | 30% | 40% |
| | | | | MC3200 | PS | PS | PS | PS |
| | | | | | 3% | 3% | 3% | 3% |
| | | | | | MC3200 | MC3200 | MC3200 | MC3200 |
| Adhesive Material | | wt % | LDPE | 75% | 75% | 75% | 50% | 75% |
| | | | | LDPE | LDPE | LDPE | LDPE | LDPE |
| | | | | 25% | 25% | 25% | 50% | 25% |
| | | | | EVA | EVA | EVA | EVA | EVA |
| Sealing Material | | wt % | EVA | EVA | EVA | EVA | EVA | EVA |
| Layer | Protective | % | ~50 | 35 | 35 | 35 | 35 | 35 |
| Distribution | Adhesive | % | ~20 | 45 | 45 | 45 | 45 | 45 |
| (as a % of | Sealing | % | ~30 | 20 | 20 | 20 | 20 | 20 |
| total film | | | | | | | | |
| thickness) | | | | | | | | |
| Haze | Total | % | Embossed | 7.7 | 7.5 | 7 | 6.5 | 5.8 |
| Gloss | Sealing | % | 10 | 119 | 120 | 123 | 122 | 128 |
| | Outermost | % | 123 | 123 | 126 | 128 | 129 | 131 |
| Elmendorf | MD² | g/mil | 12 | 138 | 104 | 8 | 8 | 8 |
| Tear | TD³ | g/mil | 15 | 15 | 12 | 51 | 50 | 31 |
| | MD^{1,2} | g | 36 | 414 | 312 | 24 | 24 | 24 |
| | TD^{1,3} | g | 45 | 45 | 36 | 153 | 150 | 93 |
| Tensile | MD² | psi | None | None | 2900 | 2800 | 2900 | 3200 |
| Yield | TD³ | psi | None | 1700 | 2000 | 2100 | 2200 | 2500 |
| | MD^{1,2} | lbf | None | None | 8.8 | 8.5 | 8.7 | 9.6 |
| | TD^{1,3} | lbf | None | 5.0 | 6.1 | 6.4 | 6.5 | 7.4 |
| Tensile | MD² | psi | 14000 | 4300 | 3500 | 3600 | 3700 | 3300 |
| Break | TD³ | psi | 14700 | 2900 | 2400 | 2500 | 2500 | 1600 |
| | MD^{1,2} | lbf | 42.1 | 13.0 | 10.5 | 11.0 | 11.2 | 10.0 |
| | TD^{1,3} | lbf | 44.0 | 8.7 | 7.1 | 7.6 | 7.4 | 4.9 |
| Elongation | MD² | % | 122 | 349 | 307 | 259 | 243 | 171 |
| | TD³ | % | 105 | 405 | 280 | 327 | 283 | 76 |
| 1% Secant | MD² | psi | 329000 | 99000 | 121000 | 109000 | 124000 | 121000 |
| Modulus | TD³ | psi | 357000 | 47000 | 79000 | 82000 | 87000 | 94000 |
| | MD^{1,2} | lbf | 9.88 | 2.98 | 3.62 | 3.26 | 3.73 | 3.64 |
| | TD^{1,3} | lbf | 10.71 | 1.41 | 2.36 | 2.47 | 2.66 | 2.81 |
| Curl | MD² | % | 25 | 94 | 89 | 88 | 81 | 88 |
| | TD³ | % | 20 | 6 | 16 | 87 | 30 | 77 |

¹Values normalized for film thickness.
²MD stands for machine direction, or parallel to the direction of processing.
³TD stands for transverse direction, or perpendicular to the direction of processing.

TABLE 7
COMPOSITION OF AND PROPERTIES FOR FIRST
THREE LAYER STRUCTURES - FIVE MIL

| | | | OPET | | | | | |
|---|---|---|---|---|---|---|---|---|
| | | | Control | Film | Film | Film | Film | Film |
| Sample | | Units | Film | 5-1 | 5-2 | 5-3 | 5-4 | 5-5 |
| Gauge | Target | mil | — | 5 | 5 | 5 | 5 | 5 |
| | Actual | mil | 3 | 4.5 | 4.64 | 4.63 | 4.67 | 4.7 |
| Protective Material | | wt % | OPET | 97% | 77% | 67% | 67% | 57% |
| | | | | K-Resin | K-Resin | K-Resin | K-Resin | K-Resin |
| | | | | 3% | 20% | 30% | 30% | 40% |
| | | | | MC3200 | PS | PS | PS | PS |
| | | | | | 3% | 3% | 3% | 3% |
| | | | | | MC3200 | MC3200 | MC3200 | MC3200 |
| Adhesive Material | | wt % | LDPE | 75% | 75% | 75% | 50% | 75% |
| | | | | LDPE | LDPE | LDPE | LDPE | LDPE |
| | | | | 25% | 25% | 25% | 50% | 25% |
| | | | | EVA | EVA | EVA | EVA | EVA |
| Sealing Material | | wt % | EVA | EVA | EVA | EVA | EVA | EVA |
| Layer | Protective | % | ~50 | 35 | 35 | 35 | 35 | 35 |
| Distribution | Adhesive | % | ~20 | 45 | 45 | 45 | 45 | 45 |
| (as a % of | Sealing | % | ~30 | 20 | 20 | 20 | 20 | 20 |
| total film | | | | | | | | |
| thickness) | | | | | | | | |
| Haze | Total | % | Embossed | 9.1 | 9.1 | 9.8 | 6.7 | 8 |
| Gloss | Sealing | | 10 | 113 | 116 | 113 | 121 | 121 |
| | Outermost | | 123 | 126 | 128 | 126 | 130 | 128 |
| Elmendorf | MD² | g/mil | 12 | 92 | 17 | 12 | 12 | 10 |
| Tear | TD³ | g/mil | 15 | 10 | 38 | 37 | 33 | 36 |
| | MD^{1,2} | g | 36 | 460 | 85 | 60 | 60 | 50 |
| | TD^{1,3} | g | 45 | 50 | 190 | 185 | 165 | 180 |
| Tensile | MD² | psi | None | 1537 | 2933 | 2911 | 2799 | 2920 |
| Yield | TD³ | psi | None | 1549 | 2066 | 2114 | 2172 | 2312 |
| | MD^{1,2} | lbf | None | 7.69 | 14.67 | 14.56 | 14.00 | 14.60 |
| | TD^{1,3} | lbf | None | 7.75 | 10.33 | 10.57 | 10.86 | 11.56 |
| Tensile | MD² | psi | 14029 | 1242 | 3286 | 2995 | 2778 | 1328 |
| Break | TD³ | psi | 14672 | 2684 | 2495 | 2417 | 2570 | 1769 |
| | MD^{1,2} | lbf | 42.09 | 6.21 | 16.43 | 14.98 | 13.89 | 6.64 |
| | TD^{1,3} | lbf | 44.02 | 13.42 | 12.48 | 12.09 | 12.85 | 8.85 |
| Elongation | MD² | % | 122 | 70 | 299 | 260 | 227 | 29 |
| | TD³ | % | 105 | 441 | 313 | 293 | 297 | 133 |
| 1% Secant | MD² | psi | 329499 | 89218 | 116989 | 117157 | 119760 | 125318 |
| Modulus | TD³ | psi | 356909 | 39697 | 72574 | 77385 | 82349 | 93075 |
| | MD^{1,2} | lbf | 9.88 | 4.46 | 5.85 | 5.86 | 5.99 | 6.27 |
| | TD^{1,3} | lbf | 10.71 | 1.98 | 3.63 | 3.87 | 4.12 | 4.65 |
| Curl | MD² | % | 25 | 86 | 87 | 87 | 36 | 86 |
| | TD³ | % | 20 | 7 | 27 | 52 | 12 | 77 |

¹Values normalized for film thickness.
²MD stands for machine direction, or parallel to the direction of processing.
³TD stands for transverse direction, or perpendicular to the direction of processing.

While the Elmendorf tear and tensile properties of the test lamination films may be lower than the OPET Control Film, the values are likely to be sufficient for many applications. However, one property that may negatively affect the final use of a film is curl. Curl is a measure of a film's ability to remain flat in an unrestrained state. During usage a film having a high degree of curl would be more difficult to handle and could interfere with the lamination process.

The OPET Control Film exhibits a low level of curl. All of the test lamination films using the first three layer structure showed a relatively large amount of curl as indicated in Tables 6 and 7. Based on the results obtained, the degree of curl may be dependent on the amount of polystyrene blended into the protective layer blend and the amount of LDPE used in the adhesive layer blend. The amount of curl may be able to be reduced by lowering the amount of polystyrene in the protective layer and the amount of LDPE in the adhesive layer. To test this proposition, a second set of three layer structures were tested, using different layer compositions and distributions.

### Second Structure for Three Layer Lamination Films

Using a second composition and layer structure, a second set of three layer lamination films were prepared. These films used a layer distribution of 50% for the protective layer 12, 30% for the adhesive layer 30, and 20% for the sealing material 62, each percentage based on the total thickness of the lamination film. The compositions tested and results obtained from tests on these films are shown in Table 8. Additionally, a second set of films were produced at a five mil film thickness, using the same layer thickness ratios. The results obtained from tests on these films are shown in Table 9. In order to compare the results obtained for these layer structures with the results for the blend compositions of Tables 6 and 7, a final structure was made using the blend composition of Tables 6 and 7 and the layer structure of Tables 8 and 9. This structure is labeled as Film A in Tables 8 and 9.

The increase in protective layer thickness and the reduction in adhesive layer thickness had a positive effect on lamination film stiffness. On average the approximate 40% increase in protective layer thickness resulted in a 25% increase in machine direction stiffness and a 35% increase in cross direction stiffness. Although the increase in protective layer thickness of the experimental films did not achieve the stiffness seen for the OPET Control Film, they are believed to be sufficient for numerous applications considering the lower cost.

An increase in the thickness of the protective layer 12 may also improve the lamination film curl. As shown by Films 3-6, 3-10, in Table 8, and Film 5-9, in Table 9, adjustment of the layer distribution and composition allows films to be made that have a similar curl to the OPET Control Film, shown in Tables 6 and 7. As expected from the results of the previous structure, the lowest curl values were obtained when the level of polystyrene in the protective layer 12 and of the LDPE in the adhesive layer 30 were lowest. At the lowest PS and LDPE levels studied, for structure 5-9, the curl values obtained on the film were lower than that determined for the OPET Control Film.

The tensile properties of the experimental lamination films using this structure were not generally as good as those of the OPET Control Film, but were better that those measured for films using the first structure. The tear properties of the films made using the second three layer structure were comparable with those of the OPET Control Film and slightly lower than the tear properties of films made using the first three layer structures.

### CONCLUSIONS FROM EXPERIMENTAL RESULTS

Based on the data obtained for the test lamination films, a three layer lamination film structure including a styrenic polymer as a protective, layer 14, an adhesive layer 30 made of an adhesive material including a LDPE/EVA blend and an EVA sealing layer 16 may provide a low cost structure for lamination applications. Such a film would not be as stiff as the OPET Control Film at the same film thickness, which may preclude its use in some segments of the market, but the material cost savings may widen its use in other applications.

For certain embodiments, the data collected during the study indicated that very favorable properties may be obtained for a three layer structure in which the polystyrene in the protective layer 12 may be limited to about 57%, the LDPE in the adhesive layer 30 may be limited to about 50% and the thickness of the adhesive layer may be limited to less than about 30%. Structures corresponding to these conditions are indicated as “3-9” and “5-9” in Tables 8 and 9.

TABLE 8
COMPOSITION OF AND PROPERTIES FOR SECOND THREE LAYER STRUCTURE -- THREE MIL

| | | | | Film | Film | Film | Film | Film |
|---|---|---|---|---|---|---|---|---|
| Sample | | Units | Film A | 3-6 | 3-7 | 3-8 | 3-9 | 3-10 |
| Gauge | Target | mil | 3 | 3 | 3 | 3 | 3 | 3 |
| | Actual | mil | 2.63 | 2.65 | 2.4 | 2.5 | 2.63 | 2.67 |
| Protective Material | | wt % | 97% | 77% | 67% | 57% | 97% | 67% |
| | | | K-Resin | K-Resin | K-Resin | K-Resin | K-Resin | K-Resin |
| | | | 3% | 20% | 30% | 40% | 3% | 30% |
| | | | MC3200 | PS | PS | PS | MC3200 | PS |
| | | | | 3% | 3% | 3% | | 3% |
| | | | | MC3200 | MC3200 | MC3200 | | MC3200 |
| Adhesive Material | | wt % | 75% | 75% | 75% | 75% | 75% | 50% |
| | | | LDPE | LDPE | LDPE | LDPE | LDPE | LDPE |
| | | | 25% | 25% | 25% | 25% | 25% | 50% |
| | | | EVA | EVA | EVA | EVA | EVA | EVA |
| Sealing Material | | wt % | EVA | EVA | EVA | EVA | EVA | EVA |
| Layer | Protective | % | 50 | 50 | 50 | 50 | 50 | 50 |
| Distribution | Adhesive | % | 30 | 30 | 30 | 30 | 30 | 30 |
| (as a % of | Sealing | % | 20 | 20 | 20 | 20 | 20 | 20 |
| total film | | | | | | | | |
| thickness) | | | | | | | | |
| Haze | Total | % | 6.8 | 6.9 | 6.1 | 5.1 | 6.8 | 6.3 |
| Gloss | Sealing | | 123 | 122 | 126 | 133 | 123 | 121 |
| | Outermost | | 126 | 128 | 130 | 130 | 126 | 131 |
| Elmendorf | MD² | g/mil | 118 | 238 | 8 | 7 | 118 | 9 |
| Tear | TD³ | g/mil | 57 | 31 | 29 | 17 | 57 | 23 |
| | MD^{1,2} | g | 354 | 714 | 24 | 21 | 354 | 27 |
| | TD^{1,3} | g | 171 | 93 | 87 | 51 | 171 | 69 |
| Tensile | MD² | psi | 2280 | 3210 | 3940 | 4071 | 2280 | 3631 |
| Yield | TD³ | psi | 1796 | 2419 | 2676 | 3116 | 1796 | 2676 |
| | MD^{1,2} | lbf | 6.84 | 9.63 | 11.82 | 12.21 | 6.84 | 10.89 |
| | TD^{1,3} | lbf | 5.388 | 7.257 | 8.028 | 9.348 | 5.388 | 8.028 |
| Tensile | MD² | psi | 4050 | 3815 | 4464 | 3783 | 4050 | 3878 |
| Break | TD³ | psi | 3157 | 3144 | 2155 | 2106 | 3157 | 1905 |
| | MD^{1,2} | lbf | 12.15 | 11.45 | 13.39 | 11.35 | 12.15 | 11.63 |
| | TD^{1,3} | lbf | 9.47 | 9.43 | 6.47 | 6.32 | 9.47 | 5.72 |
| Elongation | MD² | % | 330 | 246 | 246 | 181 | 330 | 224 |
| | TD³ | % | 405 | 323 | 206 | 118 | 405 | 150 |
| 1% Secant | MD² | psi | 117465 | 143098 | 159487 | 162191 | 117465 | 153528 |
| Modulus | TD³ | psi | 61077 | 98046 | 121037 | 134348 | 61077 | 119946 |
| | MD^{1,2} | lbf | 3.52 | 4.29 | 4.78 | 4.87 | 3.52 | 4.61 |
| | TD^{1,3} | lbf | 1.83 | 2.94 | 3.63 | 4.03 | 1.83 | 3.60 |
| Curl | MD² | % | 75 | 27 | 32 | 44 | 75 | 6 |
| | TD³ | % | 7 | 13 | 14 | 19 | 7 | 6 |

¹Values normalized for film thickness.
²MD stands for machine direction, or parallel to the direction of processing.
³TD stands for transverse direction, or perpendicular to the direction of processing.

TABLE 9
COMPOSITIONS OF AND PROPERTIES FOR SECOND
THREE LAYER STRUCTURE -- FIVE MIL

| | | | | Film | Film | Film | Film | Film |
|---|---|---|---|---|---|---|---|---|
| Sample | | Units | Film A | 5-6 | 5-7 | 5-8 | 5-9 | 5-10 |
| Gauge | Target | mil | 3 | 5 | 5 | 5 | 5 | 5 |
| | Actual | mil | 2.63 | 4.64 | 4.5 | 4.71 | 4.33 | 4.5 |
| Protective Material | | wt % | 97% | 97% | 77% | 67% | 57% | 57% |
| | | | K-Resin | K-Resin | K-Resin | K-Resin | K-Resin | K-Resin |
| | | | 3% | 3% | 20% | 30% | 40% | 40% |
| | | | MC3200 | MC3200 | PS | PS | PS | PS |
| | | | | | 3% | 3% | 3% | 3% |
| | | | | | MC3200 | MC3200 | MC3200 | MC3200 |
| Adhesive Material | | wt % | 75% | 75% | 75% | 75% | 50% | 75% |
| | | | LDPE | LDPE | LDPE | LDPE | LDPE | LDPE |
| | | | 25% | 25% | 25% | 25% | 50% | 25% |
| | | | EVA | EVA | EVA | EVA | EVA | EVA |
| Sealing Material | | wt % | EVA | EVA | EVA | EVA | EVA | EVA |
| Layer | Protective | % | 50 | 50 | 50 | 50 | 50 | 50 |
| Distribution | Adhesive | % | 30 | 30 | 30 | 30 | 30 | 30 |
| (as a % of | Sealing | % | 20 | 20 | 20 | 20 | 20 | 20 |
| total film | | | | | | | | |
| thickness) | | | | | | | | |
| Haze | Total | % | 6.8 | 7.9 | 8.3 | 6.1 | 6.7 | 6.2 |
| Gloss | Sealing | | 123 | 117 | 117 | 130 | 120 | 125 |
| | Outermost | | 126 | 125 | 128 | 132 | 130 | 134 |
| Elmendorf | MD² | g/mil | 118 | 91 | 188 | 13 | 13 | 11 |
| Tear | TD³ | g/mil | 57 | 37 | 28 | 20 | 19 | 41 |
| | MD^{1,2} | g | 354 | 455 | 940 | 65 | 65 | 55 |
| | TD^{1,3} | g | 171 | 185 | 140 | 100 | 95 | 205 |
| Tensile | MD² | psi | 2280 | 2337 | 3057 | 3428 | 3476 | 3798 |
| Yield | TD³ | psi | 1796 | 1738 | 2227 | 2572 | 2579 | 2943 |
| | MD^{1,2} | lbf | 6.84 | 11.69 | 15.29 | 17.14 | 17.38 | 18.99 |
| | TD^{1,3} | lbf | 5.39 | 8.69 | 11.14 | 12.86 | 12.90 | 14.72 |
| Tensile | MD² | psi | 4050 | 3419 | 3483 | 2417 | 2675 | 2120 |
| Break | TD³ | psi | 3157 | 3333 | 3073 | 2770 | 2818 | 3006 |
| | MD^{1,2} | lbf | 12.15 | 17.10 | 17.42 | 12.09 | 13.38 | 10.60 |
| | TD^{1,3} | lbf | 9.47 | 16.67 | 15.37 | 13.85 | 14.09 | 15.03 |
| Elongation | MD² | % | 330 | 345 | 315 | 193 | 228 | 23 |
| | TD³ | % | 405 | 443 | 368 | 266 | 271 | 287 |
| 1% Secant | MD² | psi | 117465 | 111119 | 139916 | 144122 | 148381 | 160693 |
| Modulus | TD³ | psi | 61077 | 51354 | 89117 | 107711 | 113360 | 125161 |
| | MD^{1,2} | lbf | 3.52 | 5.56 | 7.00 | 7.21 | 7.42 | 8.03 |
| | TD^{1,3} | lbf | 1.83 | 2.57 | 4.46 | 5.39 | 5.67 | 6.26 |
| Curl | MD² | % | 75.0 | 51.9 | 33.5 | 34.0 | 8.3 | 37.5 |
| | TD³ | % | 7.4 | 6.5 | 11.1 | 18.5 | 1.9 | 20.4 |

¹Values normalized for film thickness.
²MD stands for machine direction, or parallel to the direction of processing.
³TD stands for transverse direction, or perpendicular to the direction of processing.

While the techniques disclosed above may be susceptible to various modifications and alternative forms, specific embodiments have been shown by way of example in the drawings. However, it should be understood that the techniques are not intended to be limited to the particular forms disclosed. Rather, the techniques encompass all modifications, equivalents and alternatives falling within the spirit and scope of the techniques as defined by the following appended claims.

What is claimed:

1. A method of making a lamination film, comprising:
performing a cast film co-extrusion process that excludes an orientation process, wherein the cast film co-extrusion process comprises:
forming a first melt of a protective material comprising a styrenic polymer;
forming a second melt comprising a sealing material; and
co-extruding the first melt with the second melt in a coextrusion die to form the lamination film comprising a protective layer and a sealing layer, wherein the protective layer is an outermost layer in the lamination film, and wherein the lamination film has a total thickness in the range of about 3 mils to about 15 mils.

2. The method of claim 1, wherein the styrenic polymer comprises a styrene butadiene block copolymer having a styrene content of about 50% to about 95% by weight.

3. The method of claim 1, wherein the protective layer comprises a blend of the styrenic polymer with another polymer, and wherein the styrenic polymer comprises about 20% to about 98% of the blend by weight.

4. The method of claim 1, wherein the sealing material comprises an ethylene vinyl acetate, or low density polyethylene, or a combination thereof

5. The method of claim 4, wherein the ethylene vinyl acetate comprises a vinyl acetate content of about 5% to about 35% by weight.

6. The method of claim 1, wherein the protective layer comprises about 35% to about 90% of the total thickness of the lamination film.

7. The method of claim 1, wherein the sealing layer comprises about 10% to about 65% of the total thickness of the lamination film.

8. The method of claim 1, comprising:
forming a third melt of an adhesive material comprising a low density polyethylene; and
co-extruding the third melt with the first melt and the second melt in the coextrusion die to form the lamination film comprising an adhesive layer disposed between the sealing layer and the protective layer.

9. The method of claim 8, wherein the adhesive layer comprises about 25% to about 55% of the total thickness of the lamination film.

10. A method of protecting an object, comprising:
positioning the object to be protected between a first lamination film and a second lamination film, wherein the first and second lamination films are prepared using a cast film co-extrusion system that excludes an orientation process, and wherein the first lamination film comprises:
a first protective layer comprising a first protective material comprising a styrenic polymer, wherein the first protective layer is an outermost layer in the first lamination film; and
a sealing layer comprising a sealing material; wherein the first lamination film has a total thickness in the range of about 3 mils to about 15 mils; and
laminating the first lamination film with the second lamination film to substantially seal at least a portion of the object.

11. The method of claim 10, wherein the second lamination film comprises a second protective layer comprising a second protective material comprising the styrenic polymer, wherein the second protective layer is the outermost layer in the second lamination film, and wherein the second lamination film has a second total thickness in the range of about 3 mils to about 15 mils.

12. The method of claim 10, wherein the sealing layer is placed in contact with the object to be protected.

13. The method of claim 10, wherein the first lamination film comprises an adhesive layer, wherein the adhesive layer is disposed between the first protective layer and the sealing layer of the first lamination film, and wherein the adhesive layer comprises a low density polyethylene.

14. The method of claim 10, wherein the object comprises educational items, restaurant menus, photographs, historical documents, interior and outdoor signage, posted policies, marketing or sales literature, identification cards, or any combination thereof

15. The method of claim 10, wherein laminating comprises hot lamination or cold lamination.

16. The method of claim 10, wherein laminating comprises placing the object, the first lamination film, and the second lamination film through a pair of heated rollers configured to melt and exert pressure on the first lamination film and the second lamination film.

17. The method of claim 16, comprising heating the pair of heated rollers to a temperature less than approximately 115 degrees Celsius to reduce the formation of wrinkles in the first and second lamination films.

18. A system, comprising:
a first component configured to form a first melt of a protective material comprising a styrenic polymer;
a second component configured to form a second melt comprising a sealing material; and
a coextrusion die configured to co-extrude the first melt with the second melt to form a lamination film comprising a protective layer and a sealing layer, wherein the protective layer is an outermost layer in the lamination film, wherein the lamination film has a thickness in the range of about 3 mils to about 15 mils, and wherein the system excludes an orientation process component.

19. The system of claim 18, comprising a third component configured to form a third melt comprising a low density polyethylene, wherein the coextrusion die is configured to co-extrude the third melt with the first melt and the second melt to form the lamination film comprising an adhesive layer disposed between the sealing layer and the protective layer.

20. The system of claim 18, wherein the coextrusion die comprises an adjustment screw configured to control the thickness of the lamination film.
